(19) United States
(12) Patent Application Publication
(10) Pub. No.: US 2019/0256390 A1
(43) Pub. Date: Aug. 22, 2019

(54) USE OF ENCAPSULATED SUBSTRATES TO CONTROL RELAEASE RATES OF ZERO VALENT METALS

(71) Applicant: Innovative Environmental Technologies, Inc, Pipersville, PA (US)

(72) Inventors: Michael Scalzi, Doylestown, PA (US); Antonis Karachalios, Hatfield, PA (US)

(21) Appl. No.: 16/167,445

(22) Filed: Oct. 22, 2018

Related U.S. Application Data
(60) Provisional application No. 62/575,161, filed on Oct. 20, 2017.

(51) Int. Cl. C02F 1/70

(52) U.S. Cl. CPC C02F 1/705; C02F 2101/12

(57) ABSTRACT

Anaerobic reductive dechlorination processes remove chlorinated solvents from contaminated subsurface soil and ground water. The presence of zero-valent metals into the remedial mixtures provides a method of buffering the pH of the reaction and also provides a source for the iron reducing bacteria that catalyze the dehalorespiration reactions. The present invention provides an alternative method to control the release rate of the zero-valent metals during dechlorination. The invention utilizes encapsulated substrates to control the release rate of zero-valent metals, therefore prolonging the biotic and abiotic processes of anaerobic reductive dechlorination while promoting sorption of hydrophobic chlorinated volatile organic compounds into the lipid coating, further enhancing the efficacy of the zero valent metal treatment.

### PRIORITY

This application claims the priority under 35 USC § 119 of Provisional Application 62/575,161 filed on Oct. 20, 2017, entitled “Use of Encapsulated Zero Valent Metals That Control Their Release Rates Into an Aqueous Solution” and having Michael Scalzi and Antonis Karachalios as inventors. Application 62/575,161 is herein incorporated by reference in its entirety.

### BACKGROUND

Zero valent iron (ZVI), elemental metallic iron, has the ability to reduce waterborne inorganic ions by releasing soluble Fe(II) particles that further oxidize into Fe(III). In general, ZVI describes the elemental form of iron, and refers to the zero-charge carried by each atom, a result of the outer valence level being filled. These characteristics allow ZVI to convert oxidized elements, which may be toxic and soluble in water, into immobile solid forms. ZVI systems can effectively reduce contaminants such as heavy metals, chlorinated solvents, and petroleum aromatic hydrocarbons. Furthermore, another common use for ZVI is the construction of permeable reactive barriers (PRB) to intercept and dechlorinate chlorinated hydrocarbons in groundwater plumes. Currently, ZVI in both the micro and macro-scale is used in PRBs for the purposes of remediation at contaminated sites.

Chlorinated solvents are some of the most frequently occurring types of contaminants in soil and groundwater at designated Superfund and other hazardous waste sites in the United States. They are organic compounds that contain chlorine atoms and their properties make them ideal for many industrial-cleaning applications such as degreasing oils and fats. Common solvents include tetrachloroethene (PCE) and trichloroethene (TCE), used extensively in the dry-cleaning industry, and 1,1,1-trichloroethane (TCA) and Methylene Chloride typically used as industrial degreasers.

Anaerobic reductive dechlorination is one treatment process that has been successfully used to remediate soil and groundwater contaminated with chlorinated solvents. The occurrence of different types and concentrations of electron donors such as native organic matter and electron acceptors such as oxygen and chlorinated solvents determine which reductive dechlorination occurs during the natural attenuation of a site.

Reductive dechlorination only occurs in the absence of oxygen; chlorinated solvents substitute for oxygen in the physiology of the microorganisms carrying out the process. Remedial treatment technologies usually introduce an oxygen scavenger to the subsurface to ensure this process occurs immediately.

### SUMMARY

In order to address the need in the art for a zero-valent metal product that will have a staggered and steady release rate in the solution, the present invention has been devised.

This invention provides an alternative method to control the release rate of the zero-valent metal in the solution during remedial processes. The zero-valent metal product is encapsulated and that way has the potential to control the release of the metal in the solution. One of the main benefits, of this approach is the ability to control the pH level of the targeted system.

In this respect, before explaining at least one embodiment of the invention in detail, it is to be understood that the invention is not limited in its application and to the arrangements of the components and/or elements set forth in the following description or illustrated in the drawings, diagrams, or tables. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The features and advantages of the various embodiments will become apparent from the following detailed description in which:

FIG. 1 illustrates an example of a basic lipid structure.

FIG. 2 illustrates an example of a phospholipid structure.

FIG. 3 illustrates an example of a lipid bilayer structure.

FIG. 4 illustrates an example of a lipid dipalmitolyphosphatidylcholine lipid bilayer.

FIG. 5 is a microscope photograph of zero valent iron encapsulated in a lipad in a dry state, according to one embodiment

FIGS. 6A-E are microscope photographs of zero valent iron encapsulated in a lipad that has been placed in a water solution after 1-5 days respectively, according to one embodiment;

FIGS. 7A-E are microscope photographs of zero valent iron encapsulated in a lipad that has been placed in a vegetable oil solution after 1-5 days respectively, according to one embodiment;

### DETAILED DESCRIPTION OF THE PREFERRED EMBODIMENTS

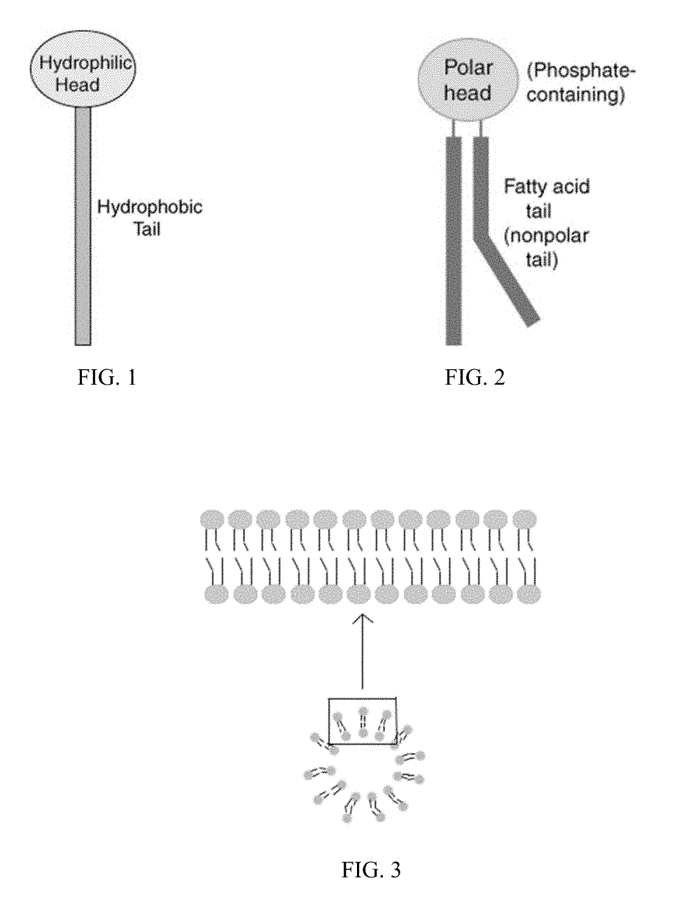

In the preferred embodiment, a lipid bilayer is the effective encapsulating mechanism. A lipid bilayer is a thin polar membrane composed of two layers of fatty acids organized in two sheets. The lipid bilayer is typically about five to ten nanometers thick and surrounds all cells providing the cell membrane structure. As seen in FIGS. 1 and 2, the lipid bilayer forms a continuous barrier around cells and thus provides a semipermeable interface between the interior and exterior of a cell and between compartments within the cell. The cell membrane of almost every living organism is made of a lipid bilayer, as are the membranes surrounding the cell nucleus and other sub-cellular structures. The lipid bilayer is the barrier that sustains ions, proteins and other molecules and prevents them from diffusing into areas where they should not be. Lipid bilayers are ideally suited to this role because, even though they are only a few nanometers in width, they are impermeable to most water-soluble (hydrophilic) molecules.

Referring now to FIGS. 1 and 3, the hydrophobic tails of each individual sheet interacting with one another, a hydrophobic interior is formed and this acts as a permeability barrier. The hydrophilic head groups interact with the aqueous medium on both sides of the bilayer. The two opposing sheets are also known as leaflets. Bilayer-forming lipids are amphipathic molecules (containing both hydrophilic and hydrophobic components). The hydrophilic fragment, typically termed the lipid head-group, is charged, or polar, whereas the hydrophobic section consists of a pair of alkyl chains (typically between 14 and 20 carbon atoms in length) as seen in FIG. 2.

The structure of the lipid bilayer explains its function as a barrier. Lipids are fats, like oil, that are insoluble in water. There are two important regions of a lipid that provide the structure of the lipid bilayer. As seen in FIG. 1, each lipid molecule contains a hydrophilic region, also called a polar head region, and a hydrophobic, or nonpolar tail region. Referring now to FIG. 2, the phospholipid molecule's polar head group contains a phosphate group. It also sports two nonpolar fatty acid chain groups as its tail.

Referring now to FIG. 3, the phospholipids organize themselves in a bilayer to hide their hydrophobic tail regions and expose the hydrophilic regions to water. This organization is spontaneous, meaning it is a natural process and does not require energy. This structure forms the layer that is the wall between the inside and outside of the cell.

Natural bilayers are usually composed of phospholipids. The phospholipid bilayer is the two-layer membrane that surrounds many types of plant and animal cells. It's made up of molecules called phospholipids which arrange themselves in two parallel layers, forming a membrane that can only be penetrated by certain types of substances. This gives the cell a clear boundary, and keeps unwanted substances out; however, it can be damaged and some types of unwanted substances can bypass it.

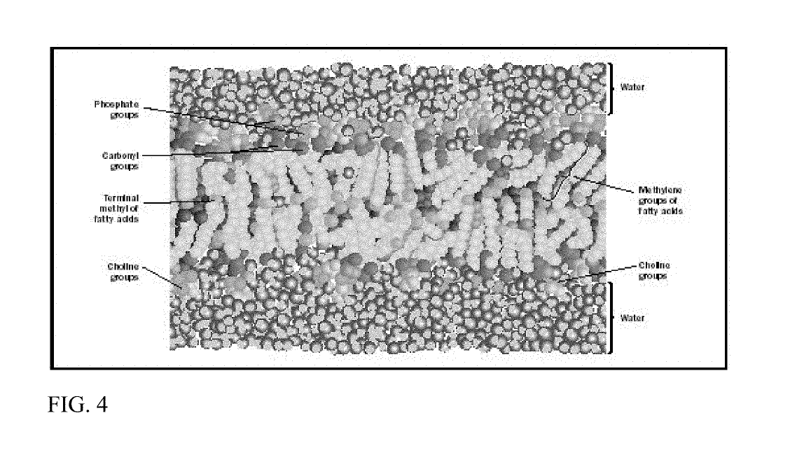

Referring now to FIG. 4, in an aqueous environment the lipids self-assemble into structures that minimize contact between water molecules and the hydrophobic components of the lipids by forming two leaflets (monolayers); this arrangement brings the hydrophobic tails of each leaflet in direct contact with each other, and leaves the head groups in contact with water.

Among a wide variety of carriers, lipid-based systems present numerous advantages over other formulations. These carriers are biocompatible, biodegradable and are easily produced by versatile and up-scalable processes. Lipid-based systems have been used for the encapsulation of a wide variety of various agents, while controlling their kinetics of release. The internal physical state of lipid core nanoparticles has been shown to dramatically affect the encapsulation, while maintaining significant prolonged release rates.

The introduction of the traditional iron species in the subsurface often presents various challenges that include but are not limited to: a) the oxidation of the iron species, which results to the formation of numerous iron (II) and iron (III) species and can be observed by the rusting of iron over time during the presence of oxygen and groundwater; b) the rapid release of organic hydrogen into the solution that can be readily consumed, thus limiting the available amount for the dehalogenic bacteria, as the reaction process keeps ongoing and c) the rapid change of pH, which could result in an unfavorable environment for the microorganisms to operate.

Based on all the above, it can be concluded, that due to the existence of the complicated structure of a potential lipid bi/multilayer electron donor, the release rates for the cations and anions in the solution are significantly enhanced and are much slower compared to single layer electron donors.

During in-situ reductive dechlorination the presence of a lipid multilayer compound proves to be very effective since it has the potential of lasting for a longer period of time in the environmental media under anaerobic conditions.

The encapsulated ZVI that is generated is hydrophobic, which allows the CVOCs to enter through a lipid membrane where it can diffuse to the ZVI particle and undergo degradation.

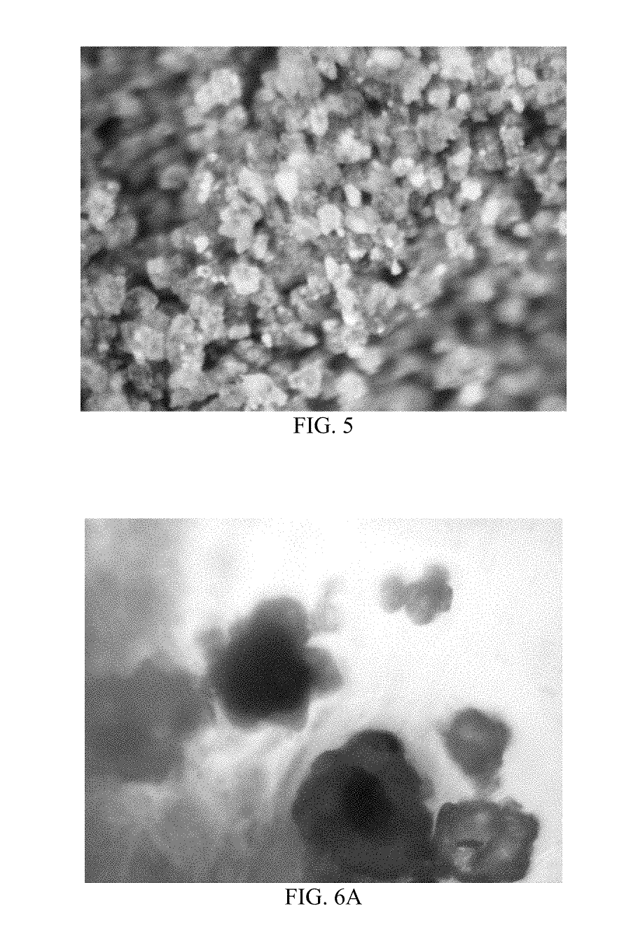

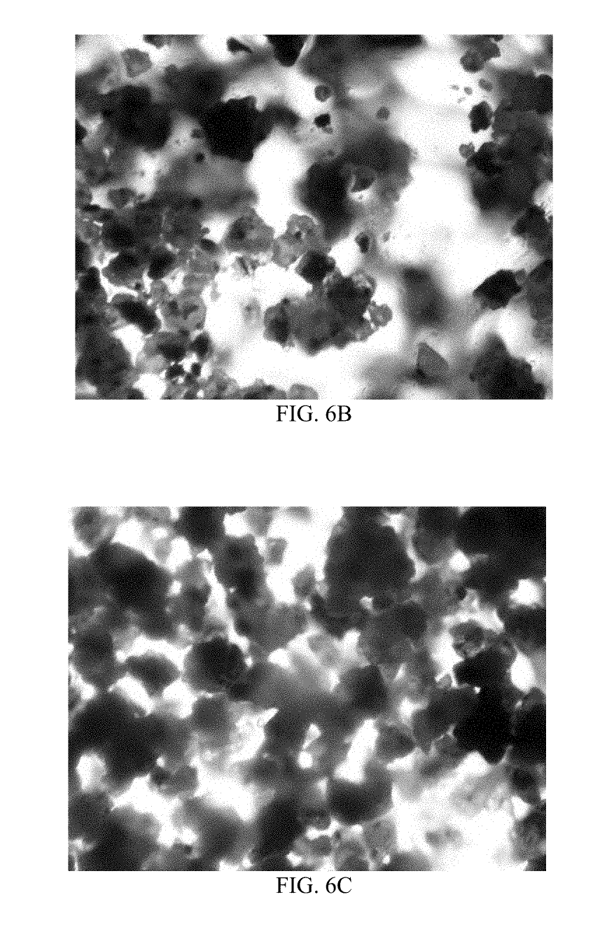

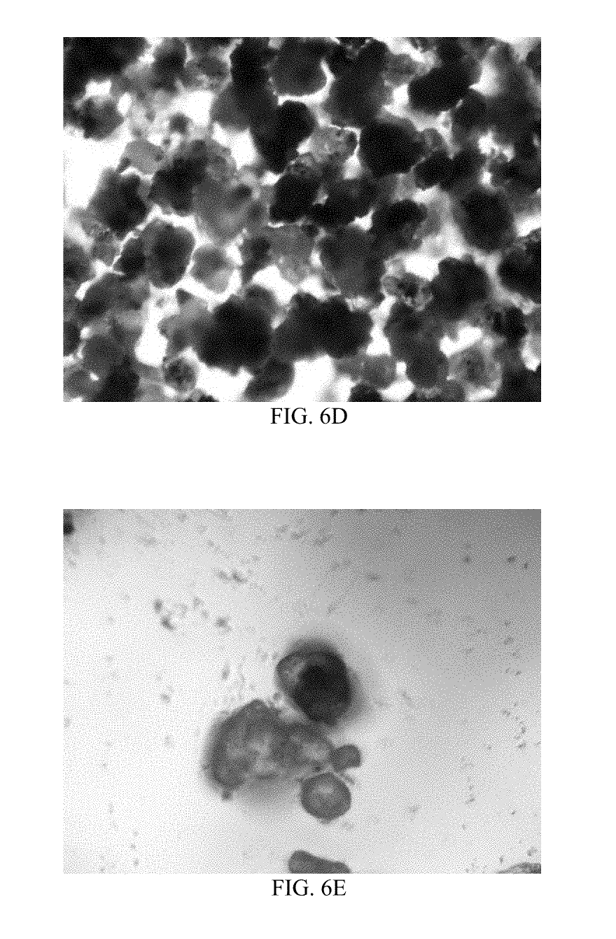

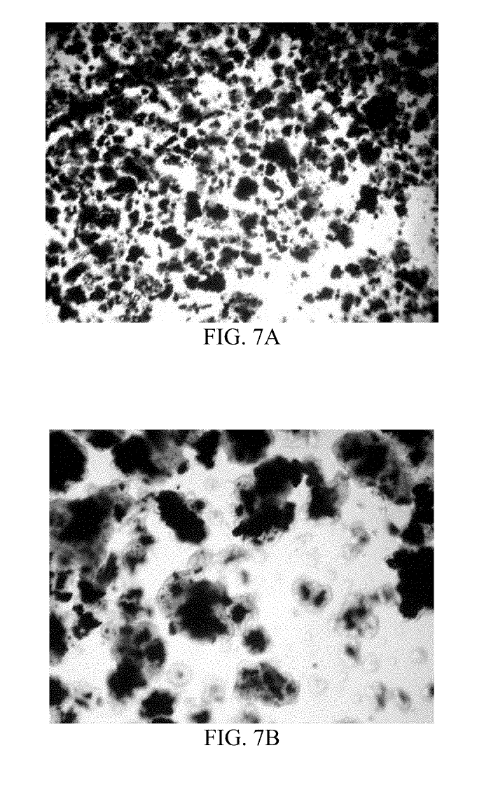

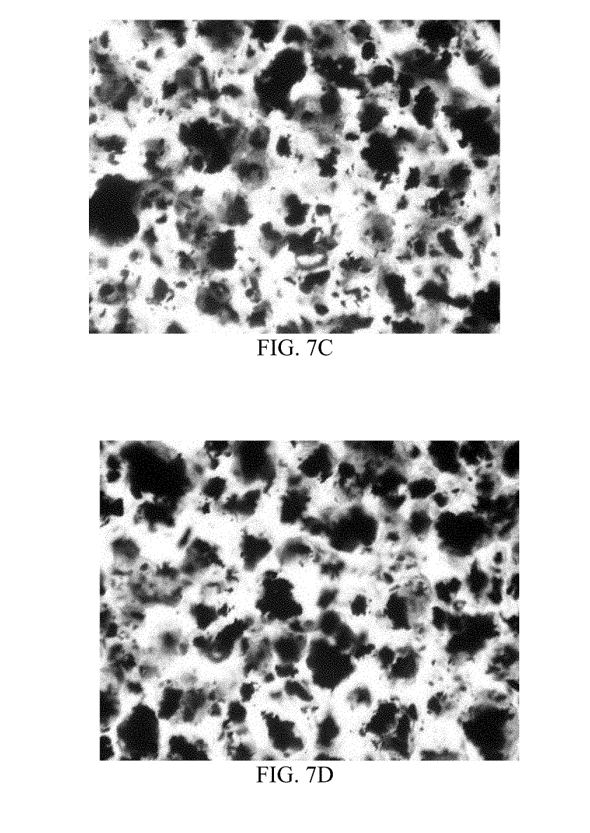

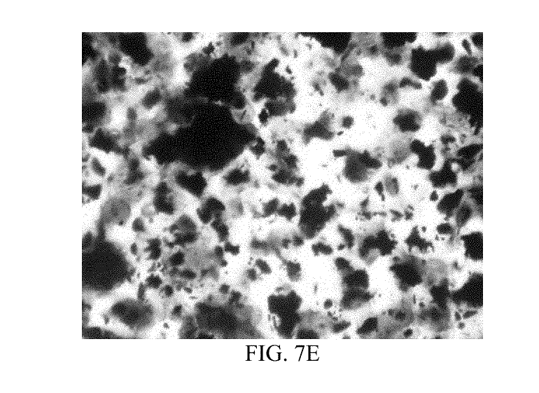

FIG. 5 is a microscope photograph of zero-valent iron encapsulated in a lipd in a dry state. FIGS. 6A-E are photographs of the zero-valent iron encapsulated in a lipid after being submerged in a water solution for 1-5 days. FIGS. 7A-E are photographs of the zero-valent iron encapsulated in a lipid after being submerged in a vegetable oil solution for 1-5 days. The microscope pictures clearly show the effective encapsulation of the ZVI particle by the lipid membrane for the dry sample and mixed in an aqueous solution. The ZVI still remained within the lipid structure 5 days after the mixing occurred.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A method for accelerated biotic dechlorination of groundwater and soils based on reductive dechlorination processes, the method comprising
introducing encapsulated zero-valent metal to the groundwater in order to provide a controlled release of zero-valent metal to stimulate the reductive dechlorination processes.

2. The method of claim 1, wherein the encapsulated zero-valent metal controllably releases the zero-valent metal.

3. The method of claim 1, wherein the zero-valent metal is zero-valent iron.

4. The method of claim 1, wherein the encapsulated zero-valent metal includes zero-valent metal encapsulated within liposomes, dendrimers or polymeric organic particles.

5. The method of claim 1, wherein the encapsulated zero-valent metal includes zero-valent metal encapsulated within a lipid membrane, wherein the lipid membrane sorbs hydrophobic contaminants and osmotically reacts with organic compounds, thus leading to their biodegradation.

6. The method of claim 1, wherein the introducing includes introducing the encapsulated zero-valent metal into the groundwater via temporary or permanent wells.

7. The method of claim 1, wherein the introducing includes introducing the encapsulated zero-valent metal into the groundwater via gravity feeding, induced gas stream, a pump, or a combination thereof.

8. The method of claim 1, wherein the introducing includes introducing the encapsulated zero-valent metal into the groundwater under pressure in either a gas or liquid stream.

9. The method of claim 1, wherein introducing includes introducing the encapsulated zero-valent metal into the soils via mechanical mixing of the soils.

10. The method of claim 1, wherein introducing includes introducing the encapsulated zero-valent metal into an open excavation prior to backfilling.

11. The method of claim 1, further comprising providing additional materials known to further promote a suitable environment for the reductive dechlorination process.

12. The method of claim 11, wherein the additional materials assist in introduction of organic hydrogen donors in the groundwater.

13. The method of claim 11, wherein the additional materials are biologically stimulating agents including vitamins, yeast extract, and biological cultures.
